(19) United States
(12) Patent Application Publication
(10) Pub. No.: US 2019/0105137 A1
(43) Pub. Date: Apr. 11, 2019

(54) DIVIDED DENTAL FLOSS SPOOL

(71) Applicant: Ranir, LLC, Grand Rapids, MI (US)

(72) Inventor: Bryan J. Dishon, Alto, MI (US)

(21) Appl. No.: 15/730,168

(22) Filed: Oct. 11, 2017

(51) Int. Cl. A61C 15/04; B65H 49/04

(52) U.S. Cl. CPC A61C 15/043; B65H 49/04

(57) ABSTRACT

A divided dental floss spool for use with a dental floss container for dispensing dental floss. The spool includes a cylindrical core having distal ends, and a circular flange disposed around the core at each distal end. The spool also includes a plurality of circular divider discs disposed around the core and positioned at spaced intervals between the flanges. Adjacent divider discs and flanges define a plurality of channels therebetween, and a length of dental floss is wound around the core within each of the plurality of channels. The act of moving between adjacent channels as the dental floss is unwound provides tactile feedback to a user to indicate that a predetermined length of dental floss has been unspooled.

### BACKGROUND OF THE INVENTION

The present invention relates to a spool for use within a dental floss container or dispenser, and more particularly, to a dental floss spool that includes multiple channels and dental floss wound within each of the channels.

It is generally well recognized that brushing the teeth alone is not completely effective in removing plaque and food particles from the crevices and contact points between the teeth. To supplement brushing, dental floss has long been used to effectively clean the spaces between the teeth and under the gum line. When used properly, dental floss has been found to be effective in inhibiting tooth decay and gum disease, and is recommended by dentists to be performed daily for proper dental hygiene.

Typically, dental floss is provided in molded, polymeric containers which have a floss outlet opening and a floss cutter element. To be used, a length of dental floss is drawn out of the container and cut using the cutter element provided on the container. Accordingly, the dental floss container manages the storage, dispensing, and cutting of selected length of dental floss.

A conventional dental floss container includes a spool or bobbin around which the dental floss is wound. The container includes an axle that rotatably supports the spool, and the spool is free to rotate when a length of dental floss is drawn out by the user. Sometimes, the dental floss can become tangled within the container during unspooling. Further, there is no indication provided to the user that a proper or sufficient length of dental floss has been pulled from the container.

### SUMMARY OF THE INVENTION

The present invention provides a divided dental floss spool for a dental floss container for dispensing dental floss. The spool includes a cylindrical core having distal ends, and a circular flange disposed around the core at each distal end. The spool also includes a plurality of circular divider discs disposed around the core and positioned at spaced intervals between the flanges. Adjacent divider discs and flanges define a plurality of channels therebetween, and a length of dental floss is wound around the core within each of the plurality of channels.

According to one embodiment, the dental floss spool includes divider discs and each divider disc includes a radially extending pass-through slot. A continuous length of dental floss is wound around the core within each of the plurality of channels, and the length of dental floss passes between adjacent channels through the pass-through slots. The act of moving between adjacent channels as the dental floss is unwound provides tactile feedback to a user to indicate that a predetermined length of dental floss has been unspooled.

According to one embodiment, the dental floss spool includes a cylindrical core having an axial length and distal ends, a circular flange disposed around the core at each distal end, and a plurality of circular divider discs disposed around the core and positioned at spaced intervals between the flanges. Adjacent divider discs and flanges define a plurality of channels therebetween, and each divider disc includes a radially extending pass-through slot. A continuous length of dental floss is wound around the core within each of the plurality of channels, and the length of dental floss passes between adjacent channels through the aligned pass-through slots. The length of dental floss is wound around the axial length of the core, back and forth in first and second axial directions, until the dental floss spool includes a predetermined length of dental floss.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and practiced or carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective, partial cut-away view of a divided dental floss spool provided in a dental floss container, according to one embodiment of the present invention;

FIG. 2 is a perspective view of the divided dental floss spool;

FIG. 3 is an end view of the divided dental floss spool;

FIG. 4 is a side view of the divided dental floss spool; and

FIG. 5 is a cross-sectional view of the divided dental floss spool taken along line V-V of FIG. 3.

### DESCRIPTION

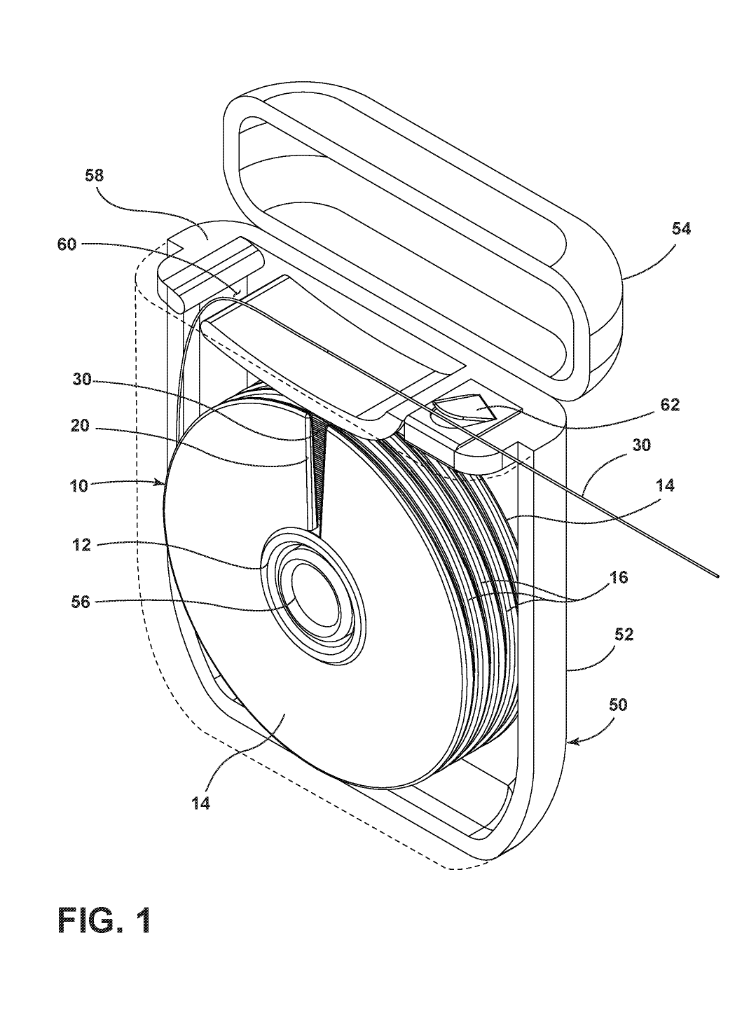

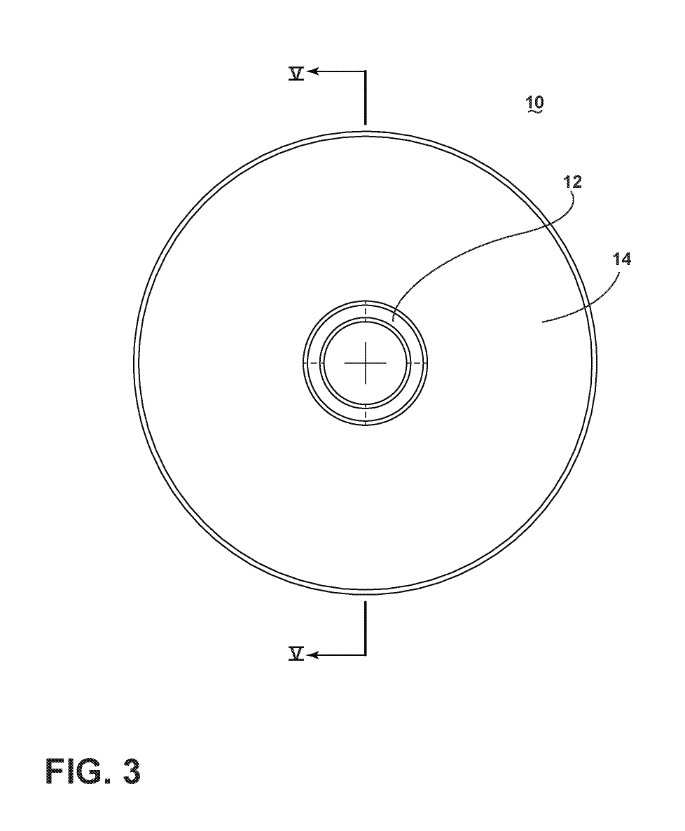

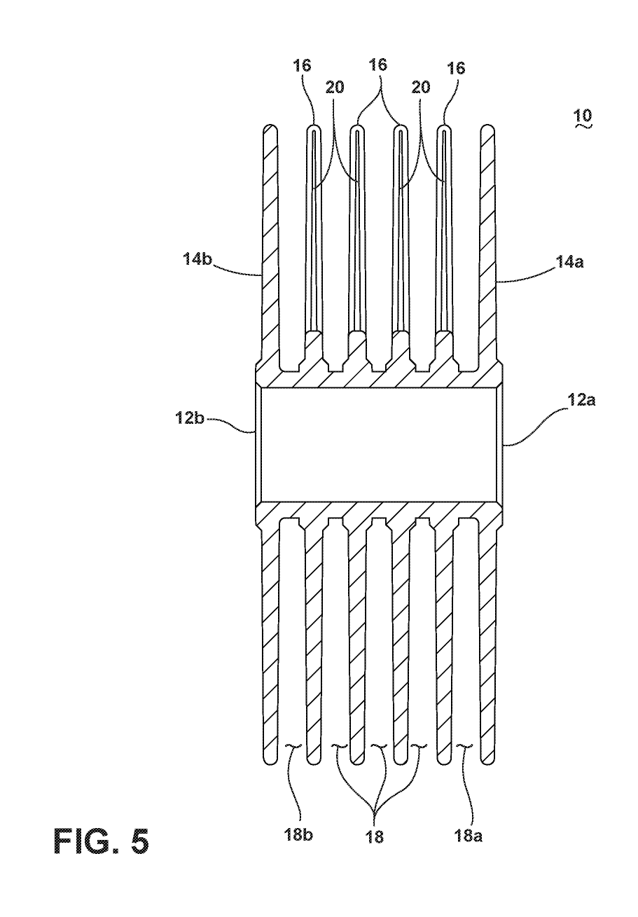

A divided dental floss spool according to one embodiment of the present invention is shown in FIGS. 1-5 and generally designated 10. The dental floss spool 10 is particularly adapted for use in a conventional dental floss container 50 or dispenser for the dispensing of conventional dental floss 30. The illustrated embodiment is shown for exemplary purposes, and the dental floss spool 10 could be implemented in a variety of floss containers, including countertop dispensers, individually packaged refills, and so on. The exemplary container 50 includes a housing 52 with a closeable cap 54. The housing 52 includes an axle 56 that rotatably supports the dental floss spool 10. A top wall 58 of the housing 52 includes an opening 60 through which the dental floss 30 passes. The top wall 58 also includes a cutting element 62 for cutting the dental floss 30 for individual use.

The dental floss spool 10 generally includes a cylindrical core 12 having distal ends 12a, 12b, circular flanges 14 disposed around the core 12 and positioned at each of the distal ends 12a, 12b, and multiple circular divider discs 16. The core 12 is hollow so that it may be rotatably mounted on the axle 56. Further, the core 12 defines an axial length between the distal ends 12a, 12b. A flange 14a, 14b is positioned at each of the respective ends 12a, 12b of the core 12. Multiple divider discs 16 are also disposed around the core 12 and positioned at spaced intervals between the flanges 14a, 14b. The flanges 14a, 14b and divider discs 16 radially extend from the core 12 and are arranged to extend perpendicular to the axis of the core 12.

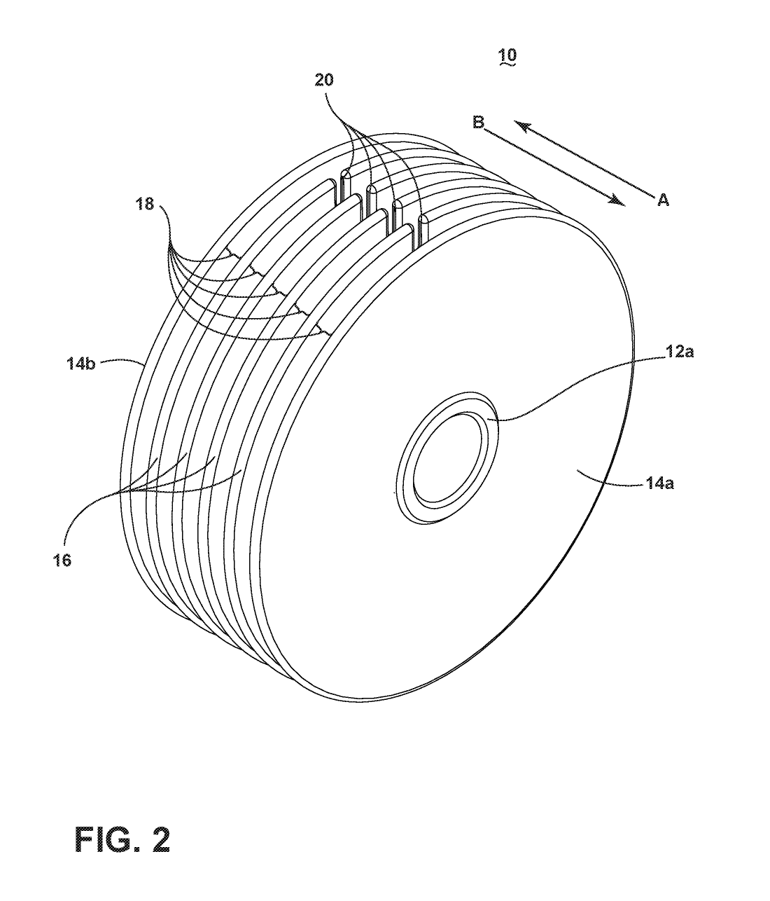

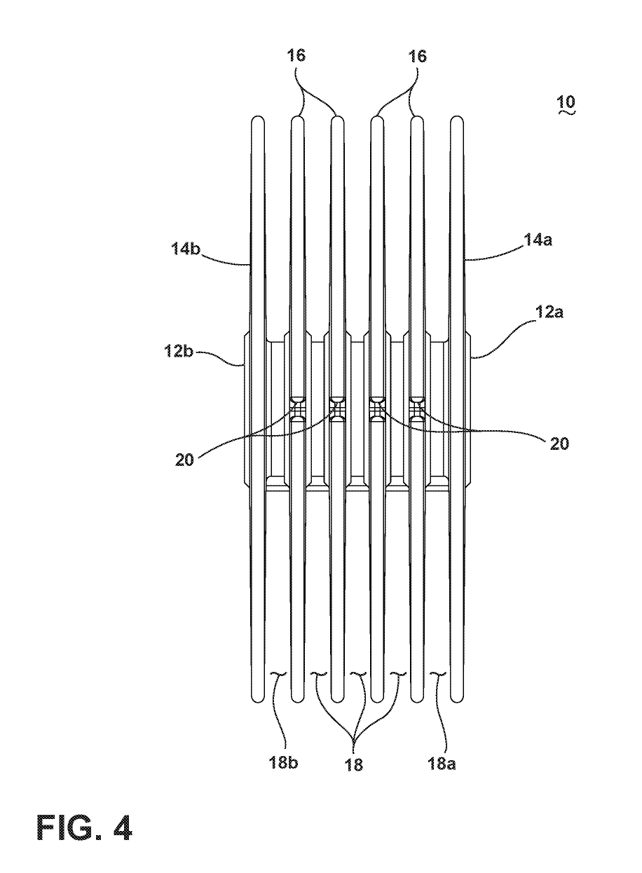

Referring in particular to FIGS. 2 and 4, the exemplary dental floss spool 10 is illustrated to include four divider discs 16. Adjacent divider discs 16, and the two divider discs 16 adjacent the flanges 14, define a plurality of channels 18 therebetween. Accordingly, the exemplary dental floss spool 10 includes five channels 18. Three channels 18 are formed between adjacent interior divider discs 16, and the two outermost channels 18a, 18b are formed between the outermost divider discs 16 and respective flanges 14a, 14b. Of course, it should be readily understood that more or fewer divider discs, and therefore more or fewer channels, could be implemented with the present dental floss spool.

Referring to FIG. 2, each divider disc 16 includes a radially extending pass-through slot 20. The pass-through slot 20 extends substantially the distance between the inner diameter and the outer diameter/perimeter of the divider disc 16. Further, the slots 20 in the multiple divider discs 16 are axially aligned; that is to say, the slots 20 in the divider discs 16 are aligned in a direction extending along the length of the core 12.

Multiple revolutions of a dental floss 30 are wound around the core 12, as is common. More particularly, dental floss 30 is wound around the core 12 within each of the channels 18. The length of dental floss 30 is continuous and passes between adjacent channels 18 through the aligned pass-through slots 20. When the dental floss 30 is wound around the core 12, within the channels 20, the floss 30 passes from channel 18 to adjacent channel 18, moving in a first axial direction A. The floss 30 is wound around the core 12, within the channels 18 and passing through the slots 20 until an outermost channel 18b at the distal end 12b of the core 12 is reached. As such, each channel 18 is wound with multiple revolutions of floss 30 prior to moving to the next channel 18, thereby forming a first wound layer of dental floss.

Once the outermost channel 18b is reached and floss 30 is wound around the core 12 within that channel, another layer of the length of dental floss 30 is wound around the core 12. This subsequent layer of dental floss 30 is wound around the core 12, passing from channel 18 to adjacent channel 18, moving in a second, opposite axial direction B. The floss 30 is wound around the core 12, within the channels 18 and passing through the slots 20 until an opposite outermost channel 18a at the opposite distal end 12a of the core 12 is reached. Dental floss 30 is wound around the core 12, back and forth in the first and the second axial directions A and B, until the dental floss spool 10 is wound to include a predetermined length of dental floss 30. Accordingly, each channel 18 includes multiple layers or revolutions of dental floss 30 wound on top of one another.

Further, the length of dental floss 30 that is disposed in each layer of each of the channels 18 defines a segment 32 of dental floss 30. Each segment 32 of dental floss 30 defines a usable length of dental floss appropriate for a single flossing. Thus, each channel 18 stores multiple layers of individual, prescribed lengths, or segments of dental floss 30. For example, 18″ of floss 30 may be provided in each layer disposed within each channel 18.

It should be understood that there is a mathematical relationship between the diameter of the core 12 (or the previous layer of dental floss 30), the preferred length of dental floss 30, and the number of revolutions which the floss 30 is wound around the core 12. There also exists a mathematical relationship between the width of the channel 18, the width of the strand of floss 30, and the number of revolutions which the floss 30 is wound around the core 12. For example, an 18″ length of floss 30, would require 12 of revolutions around a Ø0.5″ core 12. Further, using a standard width floss 30 and 12 revolutions, the width of the channel 18 is designed to be 0.1″.

Dental floss 30 is pulled out of the container 50 in a conventional manner: a user holds the free end of the dental floss 30 and pulls out a desired length as the dental floss spool 10 unwinds. As the dental floss 30 unwinds, the floss 30 moves between adjacent channels 18 through the pass-through slot(s) 20 and provides a tactile feedback to a user. In other words, the dental floss 30 transitioning between channels 18 as the dental floss 30 is unwound can be felt by the user. This tactile feedback provides an indication to the user that an appropriate length, for example, one segment 32, of dental floss 30 has been pulled from the container 50 and can then be cut from the spool 10 using the cutting element 62.

The dental floss spool 10 and container 50 described herein provide storage for a predetermined length of dental floss. Additionally, the dental floss spool 10 and container 50 are configured to store predetermined increments of floss; for example, individual use increments. The dental floss spool 10 provides an indication to a user that a proper amount of dental floss has been unspooled for use. This saves the user from wasting floss by pulling a too long a length of floss out, or, oppositely, pulling too short of a length out and then having to throw it away and grab another segment because the first segment was too short to use. Additionally, the present dental floss spool 10 helps to prevent dental floss from tangling during unspooling, which is a problem that conventional dental floss containers are often challenged with.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit of the invention and broader aspects of the invention as defined in the appended claims, which are to be interpreted in accordance with the principles of patent law, including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A divided dental floss spool for a dental floss container, the spool comprising:
a cylindrical core having distal ends;
a circular flange disposed around the core and positioned at each distal end; and
a plurality of circular divider discs disposed around the core at spaced intervals between the flanges, wherein adjacent divider discs and flanges define a plurality of channels therebetween, and a length of dental floss is wound around the core within each of the plurality of channels.

2. The dental floss spool of claim 1 wherein each divider disc includes a radially extending pass-through slot.

3. The dental floss spool of claim 2 wherein the pass-through slots are axially aligned with one another.

4. The dental floss spool of claim 3 wherein the length of dental floss is continuous and passes between adjacent channels through the aligned pass-through slots.

5. The dental floss spool of claim 4 wherein the length of dental floss is wound around the core, moving from channel to adjacent channel in a first axial direction until an outermost channel at the distal end of the core is reached, thereby forming a first layer of dental floss.

6. The dental floss spool of claim 5 wherein after the outermost channel is reached, another layer of the length of dental floss is wound around the core, moving from channel to adjacent channel in a second, opposite axial direction until an opposite outermost channel at the opposite distal end of the core is reached.

7. The dental floss spool of claim 6 wherein the length of dental floss is wound around the core, back and forth in the first and the second axial directions, until the dental floss spool includes a predetermined length of dental floss.

8. The dental floss spool of claim 7 wherein the act of moving between adjacent channels as the dental floss is unwound provides tactile feedback to a user to indicate that a predetermined length of dental floss has been unspooled.

9. The dental floss spool of claim 7 wherein the length of dental floss disposed within each of the plurality of channels defines a segment of dental floss, and each segment of dental floss defines a usable length of dental floss for a single flossing.

10. A divided dental floss spool for the dispensing of dental floss, the spool comprising:
a cylindrical core having distal ends;
a circular flange disposed around the core at each distal end; and
a plurality of circular divider discs disposed around the core and positioned at spaced intervals between the flanges, adjacent divider discs and flanges define a plurality of channels therebetween, and each divider disc includes a radially extending pass-through slot;
wherein a continuous length of dental floss is wound around the core within each of the plurality of channels, the length of dental floss passes between adjacent channels through the pass-through slots, wherein the act of moving between adjacent channels as the dental floss is unwound provides tactile feedback to a user to indicate that a predetermined length of dental floss has been unspooled.

11. The dental floss spool of claim 10 wherein the pass-through slots are axially aligned with one another.

12. The dental floss spool of claim 11 wherein the length of dental floss is wound around the core, moving from channel to adjacent channel in a first axial direction until an outermost channel at the distal end of the core is reached, thereby forming a first layer of dental floss,
wherein a second layer of dental floss is wound around the core, moving from channel to adjacent channel in a second, opposite axial direction until an opposite outermost channel at the opposite distal end of the core is reached.

13. The dental floss spool of claim 12 wherein the length of dental floss is wound around the core back and forth in the first and the second axial directions until the dental floss spool includes a predetermined length of dental floss.

14. The dental floss spool of claim 10 wherein the length of dental floss disposed within each of the plurality of channels defines a segment of dental floss, and each segment of dental floss defines a usable length of the dental floss for a single flossing.

15. The dental floss spool of claim 14 wherein the relationship between a diameter of the core and a number of revolutions of dental floss around the core to provide a segment of dental floss within a channel is inversely proportional.

16. A divided dental floss spool for the dispensing of dental floss, the spool comprising:
a cylindrical core having an axial length and distal ends;
a circular flange disposed around the core at each distal end; and
a plurality of circular divider discs disposed around the core and positioned at spaced intervals between the flanges, adjacent divider discs and flanges defining a plurality of channels therebetween, and each divider disc including a radially extending pass-through slot;
wherein a continuous length of dental floss is wound around the core within each of the plurality of channels, the length of dental floss passing between adjacent channels through the aligned pass-through slots, wherein the length of dental floss is wound around the axial length of the core, back and forth in first and second axial directions, until the dental floss spool includes a predetermined length of dental floss.

17. The dental floss spool of claim 16 wherein the length of dental floss is wound around the axial length of the core, moving from channel to adjacent channel in the first axial direction until an outermost channel at the distal end of the core is reached, thereby forming a first layer of dental floss.

18. The dental floss spool of claim 17 wherein after the outermost channel is reached, another layer of the length of dental floss is wound around the axial length of the core, moving from channel to adjacent channel in the second, opposite axial direction until an opposite outermost channel at the opposite distal end of the core is reached.

19. The dental floss spool of claim 16 wherein the act of moving between adjacent channels as the dental floss is unwound provides tactile feedback to a user to indicate that a predetermined length of dental floss has been unspooled.

20. The dental floss spool of claim 16 wherein the length of dental floss disposed within each of the plurality of channels defines a segment of dental floss, and each segment of dental floss defines a usable length of the dental floss for a single flossing.
